(19) United States
(12) Patent Application Publication
(10) Pub. No.: US 2018/0230860 A1
(43) Pub. Date: Aug. 16, 2018

(54) WASTE HEAT UTILIZATION ASSEMBLY OF AN INTERNAL COMBUSTION ENGINE, AND A METHOD FOR OPERATING SAID WASTE HEAT UTILIZATION ASSEMBLY

(71) Applicant: Robert Bosch GmbH, Stuttgart (DE)

(72) Inventor: Eberhard Maier, Koengen (DE)

(21) Appl. No.: 15/750,463

(22) PCT Filed: Jun. 8, 2016
(86) PCT No.: PCT/EP2016/062997

§ 371 Date: Feb. 5, 2018

(30) Foreign Application Priority Data
Aug. 3, 2015 (DE) 10 2015 214 727.4

(51) Int. Cl. F01K 23/06; F01K 23/10; F02G 5/02

(52) U.S. Cl. CPC F01K 23/065; F02G 5/02; F01K 23/106

(57) ABSTRACT

The invention relates to a waste-heat utilisation assembly (1) of an internal combustion engine (50), comprising a working circuit (2) that conducts a working fluid. In said working circuit (2) are arranged, in the direction of flow of the working fluid, a feed pump (6), an evaporator (10), an expansion machine (3) and a condenser (4). The evaporator (10) is also arranged in an exhaust tract (53) of said internal combustion engine (50). Between the evaporator (10) and the condenser (4), an auxiliary line (2b) is connected in parallel to the working circuit (2). According to the invention, a sub-stream evaporator (12) is arranged in the auxiliary line (2b) and a pressure sensor (14) and/or a temperature sensor (13) are also arranged in said auxiliary line (2b), said pressure sensor (14) and/or temperature sensor (13) being arranged downstream of the sub-stream evaporator (12).

### BACKGROUND OF THE INVENTION

The invention concerns a waste heat utilization assembly of an internal combustion engine and a method for operating the waste heat utilization assembly.

Waste heat utilization assemblies of internal combustion engines are known in the prior art, such as the application laid open DE 10 2010 063 701 A1. The known waste heat utilization assembly of an internal combustion engine comprises a working circuit that conducts a working fluid, wherein there are arranged in the working circuit, in the direction of flow of the working fluid, a feed pump, an evaporator, an expansion machine and a condenser. The evaporator is also arranged in an exhaust tract of the internal combustion engine. Furthermore, the known waste heat utilization assembly comprises a regulating device for regulating the steam temperature and steam pressure. For this, a pressure sensor and a temperature sensor are arranged between heat exchanger and expansion machine.

The known waste heat utilization assembly therefore has a well-functioning regulation as long as the working fluid is in the saturated steam state between evaporator and expansion machine, so that the pressure and/or the temperature of the working fluid continues to rise as further energy is supplied. But if the working fluid is in the wet steam region, in which the pressure and the temperature remain constant over a large range despite energy supplied by the evaporator, a precise determination of the state of the working fluid is not possible. For example, it cannot be ascertained whether the wet steam has 10% or 90% steam in its state.

Also, on account of sensor tolerances, evaporator drift, and mass flow drift, an exact control of the quantity of heat supplied to the working circuit by the evaporator is hardly possible.

### SUMMARY OF THE INVENTION

The waste heat utilization assembly of an internal combustion engine according to the invention on the contrary has the advantage that an exact control or regulation is also possible in the wet steam range of the working fluid. As a result, the control or regulation is very fast and robust. Thus, possible overheating of the components of the working circuit, especially the evaporator and the expansion machine, is prevented. As a result, the service life of the overall waste heat utilization assembly is increased.

For this, the waste heat utilization assembly comprises a working circuit that conducts a working fluid, wherein there are arranged in the working circuit, in the direction of flow of the working fluid, a feed pump, an evaporator, an expansion machine and a condenser. The evaporator is also arranged in an exhaust tract of the internal combustion engine. Between the evaporator and the condenser, an auxiliary line is connected in parallel to the working circuit. According to the invention, a sub-stream evaporator is arranged in the auxiliary line and furthermore a pressure sensor and/or a temperature sensor are arranged in the auxiliary line, the pressure sensor and/or the temperature sensor being arranged downstream of the sub-stream evaporator.

In this way, thermal energy can be supplied by the sub-stream evaporator to the working fluid in the auxiliary line. The changes in state of the working fluid can then be monitored by means of the pressure sensor or the temperature sensor. Preferably, the mass flow of the working fluid through the auxiliary line is distinctly less than the mass flow of the working fluid through the working circuit, so that even a slight supply of energy already results in a significant change in the enthalpy.

In a corresponding method according to the invention, enough thermal energy is supplied by the sub-stream evaporator to the working fluid in the wet steam state in the auxiliary line until the steam in the auxiliary line is saturated and the temperature then rises. This temperature rise is detected by the temperature sensor. In this way, once again the enthalpy of the working fluid in the working circuit can be deduced.

Advantageously, the sub-stream evaporator is actuable by a control unit. Thus, a determination of the state of enthalpy can be performed by the control unit as needed, preferably when the working fluid is in the wet steam state. The wet steam state can be detected by the pressure sensor or the temperature sensor, for example with the aid of specific pressure or temperature values for the particular working fluid. The control unit can then actuate the sub-stream evaporator so that it supplies a certain quantity of heat to the working fluid flowing through the auxiliary line.

In advantageous embodiments, the sub-stream evaporator is operable with electric energy. In this way, the quantity of heat can be supplied very quickly to the auxiliary line. At the same time, a very precise detecting and dosing of the quantity of heat is possible.

In advantageous modifications, a throttle is arranged in the auxiliary line upstream of the sub-stream evaporator. In this way, it is possible to ascertain or establish the ratio of the mass flow of working fluid flowing through the auxiliary line and the mass flow of working fluid flowing through the main line or through the working circuit. With this ratio, in turn, it is possible to ascertain what quantity of energy needs to be supplied to the working circuit in order to obtain saturated steam or superheated steam. Alternatively, it is also possible to ascertain, for example, how much the mass flow of working fluid through the working circuit needs to be reduced in order to obtain saturated steam or superheated steam. This can be achieved, for example, by reducing the power of the feed pump.

In advantageous embodiments, the auxiliary line is arranged between the evaporator and the expansion machine. In this way, the enthalpy of the working fluid supplied to the expansion machine can be determined free of leakage.

In advantageous alternative embodiments, the auxiliary line is designed as a bypass line to the expansion machine. In this way, the enthalpy determination has a leakage with respect to the expansion machine, but the bypass line is needed anyway if the expansion machine needs to be operated only with saturated or superheated steam in order to avoid damage, in particular cavitation damage. Thus, the enthalpy determination of the working fluid in the wet steam state would be nearly leak-free. At the same time, an already present auxiliary line, namely the bypass line, can be used. This is an especially economical and space-saving design.

In one advantageous modification, a bypass valve divides the mass flow of the working fluid between the expansion machine and the auxiliary line or the bypass line. Thus, the bypass valve can on the one hand protect the expansion machine against harmful wet steam and on the other hand supply working fluid to the auxiliary line as needed, in order to determine the enthalpy. Advantageously, the bypass valve is actuated by a control unit which also processes the sensor data of the temperature sensor and/or the pressure sensor.

In advantageous modifications, the working circuit comprises a parallel circuit with a first parallel line and a second parallel line. The evaporator is arranged in the first parallel line, and a further evaporator is arranged in the second parallel line. In this way, additional thermal energy can be supplied to the working circuit through the further evaporator. Preferably, the further evaporator is arranged at the same time in an exhaust gas recirculation duct, so that the heat of the exhaust gas recirculated to the internal combustion engine is used as an energy source.

Advantageously, the auxiliary line is arranged as a parallel circuit in the first parallel line. Another auxiliary line with another sub-stream evaporator is arranged as a parallel circuit in the second parallel line. Thus, the enthalpy of the working fluid can also be determined for the second parallel line in the manner described above. For this, a further temperature sensor and/or a further pressure sensor is arranged in the other auxiliary line downstream of the other sub-stream evaporator.

In the following, methods according to the invention for the operation of a waste heat utilization assembly of an internal combustion engine shall be shown:

In a first method, the waste heat utilization assembly comprises a working circuit that conducts a working fluid, wherein there are arranged in the working circuit, in the direction of flow of the working fluid, a feed pump, an evaporator, an expansion machine and a condenser. The evaporator is also arranged in an exhaust tract of the internal combustion engine. Between the evaporator and the expansion machine, an auxiliary line is connected in parallel to the working circuit. A sub-stream evaporator, a pressure sensor and/or a temperature sensor are arranged in the auxiliary line, the pressure sensor and/or the temperature sensor being arranged downstream of the sub-stream evaporator. The waste heat utilization assembly furthermore comprises a control unit.

The method is characterized by the following method steps:
The pressure sensor and/or the temperature sensor relays data to the control unit. Alternatively, other pressure or temperature sensors may also relay data to the control unit.
Determination of a wet steam state of the working fluid by the control unit by means of the temperature and/or pressure of the working fluid.
Increasing the heat output of the sub-stream evaporator to the auxiliary line by the control unit, until the working fluid flowing through the auxiliary line reaches a superheated steam state.
Determination by the control unit of the partial heat quantity of the heat input needed to reach the superheated steam state.

In an alternative embodiment, the control unit can also ascertain the wet steam state by means of other pressure and/or temperature sensors arranged in the working circuit.

The wet steam state is ascertained for the specific working fluid by means of the temperature and/or the pressure, for example, when the working fluid is at the evaporation temperature. Thereupon, the working fluid flowing in the auxiliary line is superheated by the sub-stream evaporator. Thus, the method ascertains not only the temperature and/or the pressure of the working fluid in the liquid or steam state, but it can also ascertain the enthalpy of the working fluid in the wet steam state.

In one advantageous modification, the working circuit comprises a parallel circuit with a first parallel line and a second parallel line. The evaporator is in this case arranged in the first parallel line, and a further evaporator is arranged in the second parallel line. The auxiliary line is arranged as a parallel circuit in the first parallel line. Another auxiliary line with another sub-stream evaporator is arranged as a parallel circuit in the second parallel line. The method is characterized in that the control unit controls a heat input of the other sub-stream evaporator to the other auxiliary line until the working fluid flowing through the other auxiliary line reaches a superheated steam state.

In this way, both the partial heat quantity through the first auxiliary line needed to reach the superheated steam state and the partial heat quantity through the other auxiliary line are ascertained. Preferably, the other evaporator is arranged in an exhaust gas recirculation duct of the internal combustion engine. In advantageous modifications, the mass flows of the working fluid through the two evaporators can be controlled with the aid of the partial heat quantities so determined, for example in order for the working fluid flowing in the expansion machine to have a superheated steam state.

In an alternative advantageous method, the waste heat utilization assembly comprises a working circuit that conducts a working fluid, wherein there are arranged in the working circuit, in the direction of flow of the working fluid, a feed pump, an evaporator, an expansion machine and a condenser. The evaporator is also arranged in an exhaust tract of the internal combustion engine. An auxiliary line is connected as a bypass line in parallel to the expansion machine. A sub-stream evaporator, a pressure sensor and/or a temperature sensor are arranged in the auxiliary line, the pressure sensor and/or the temperature sensor being arranged downstream of the sub-stream evaporator. The waste heat utilization assembly furthermore comprises a control unit.

In alternative embodiments, the auxiliary line can also be arranged as a parallel circuit within the bypass line.

The method is characterized by the following method steps:
Determination of a wet steam state of the working fluid by the control unit by means of the temperature and/or pressure of the working fluid. For this, preferably the pressure sensor and/or the temperature sensor relays data to the control unit; however, alternative pressure or temperature data may also be used.
Increasing the heat output of the sub-stream evaporator to the auxiliary line by the control unit, until the working fluid flowing through the auxiliary line reaches a superheated steam state.
Determination by the control unit of the partial heat quantity of the heat input needed to reach the superheated steam state.

For this method as well, the wet steam state is advantageously ascertained for the specific working fluid by means of the temperature and/or the pressure, for example, when the working fluid is at the evaporation temperature. Thereupon, the working fluid flowing in the auxiliary line is superheated by the sub-stream evaporator. Thus, the method ascertains not only the temperature and/or the pressure of the working fluid in the liquid or steam state, but it can also ascertain the enthalpy of the working fluid in the wet steam state. The benefit of arranging the sub-stream evaporator in the bypass line is that the working fluid in the wet steam state needs to be conducted past the expansion machine anyway, in order to prevent damage.

In one advantageous embodiment, a bypass valve divides the mass flow of the working fluid between the expansion machine and the auxiliary line. The control unit controls the bypass valve so that no working fluid in the wet steam state flows through the expansion machine. This prevents damage in the expansion machine, especially that caused by cavitation.

In advantageous modifications of the method, the control unit determines a total heat quantity needed to achieve the superheated steam state of the working fluid in the working circuit. Preferably, this is accomplished by a throttle ratio or by the flow cross section of the auxiliary line to the working circuit. In this way, the advantageously relatively small partial mass flow through the auxiliary line as compared to the total mass flow can be ascertained, and consequently the overall heat quantity in relation to the partial heat quantity. The sub-stream evaporator then only needs to supply relatively little thermal energy to the working fluid when the throttle ratio is low. In this way, the ascertaining of the wet steam state or the ascertaining of the energy quantity needed to convert the total mass flow to the superheated steam state is done in a very energy-saving manner.

In one advantageous embodiment, the control unit actuates the feed pump so that the mass flow of working fluid through the working circuit is decreased in accordance with the required total heat quantity. This reduces the energy needed to convert the working fluid of the working circuit from the wet steam state to the superheated steam state. If the waste heat utilization assembly comprises a plurality of evaporators, then a distributor valve for example can also apportion the mass flow of working fluid among the respective evaporators in accordance with the heat quantity available to the individual evaporators. This increases the efficiency of the waste heat utilization assembly.

Furthermore, the heat quantity flowing through the exhaust gas tract can also alternatively be regulated by the control unit, for example by an exhaust gas bypass valve, so that the working fluid through the evaporator, and also optionally through the other evaporator, is converted to the superheated steam state.

### BRIEF DESCRIPTION OF THE DRAWINGS

FIG. 1 shows schematically a waste heat utilization assembly of an internal combustion engine according to the invention, only the essential regions being represented.

FIG. 2 shows schematically another waste heat utilization assembly of an internal combustion engine according to the invention, only the essential regions being represented.

FIG. 3 shows schematically another waste heat utilization assembly of an internal combustion engine according to the invention, only the essential regions being represented.

FIG. 4 shows schematically another waste heat utilization assembly of an internal combustion engine according to the invention, only the essential regions being represented.

FIG. 5 shows an exemplary entropy/temperature diagram of a waste heat utilization assembly.

### DETAILED DESCRIPTION

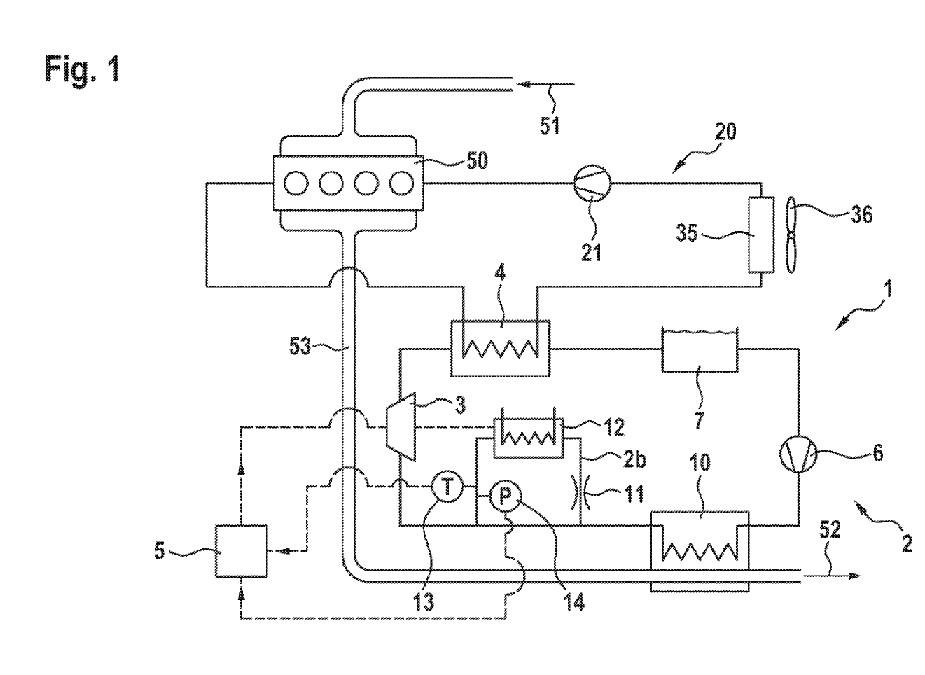

FIG. 1 shows schematically a waste heat utilization assembly 1 of an internal combustion engine 50 according to the invention with a working circuit 2 conducting a working fluid. The internal combustion engine 50 is furthermore arranged in a cooling circuit 20.

The internal combustion engine 50 is supplied at the intake side with fresh air 51, which may also contain recirculated exhaust gas of the internal combustion engine 50. At the outlet side, the internal combustion engine 50 comprises an exhaust tract 53, through which the exhaust gas 52 is expelled from the internal combustion engine.

The working circuit 2 comprises, in the direction of flow of the working fluid, a collecting tank 7, a feed pump 6, an evaporator 10, an expansion machine 3 and a condenser 4. The evaporator 10 is arranged at the same time in the exhaust tract 53, so that the thermal energy of the exhaust gas can be transferred from the exhaust tract 53 to the working circuit 2. Optionally, the collecting tank 7 in alternative embodiments may also be arranged in a feed line or branch line, not shown.

The cooling circuit 20 comprises, in the direction of flow of the coolant, a coolant pump 21, the internal combustion engine 50, the condenser 4 and a cooler 35 with a fan wheel 36. The condenser 4 is arranged both in the working circuit 2 and in the cooling circuit 20; that is, the condenser 4 draws thermal energy from the working circuit 2 and feeds it to the cooling circuit 20.

According to the invention, an auxiliary line 2b is arranged between the evaporator 10 and the expansion machine 3 in parallel with the working circuit 2. In the auxiliary line 2b are arranged, in the direction of flow of the working fluid, a throttle 11 and a sub-stream evaporator 12. Downstream of the sub-stream evaporator 12 are furthermore arranged in the auxiliary line 2b a temperature sensor 13 and a pressure sensor 14, the sequence of the two sensors 13, 14 not being critical. Preferably, the throttle 11 throttles the mass flow of the working fluid enough so that only a slight portion flows through the auxiliary line 2b.

A control unit 5 receives the data or signals determined by the temperature sensor 13 and the pressure sensor 14 and processes them further. The control unit 5 also controls and measures the energy supplied to the auxiliary line 2b by the sub-stream evaporator 12.

With the waste heat utilization assembly 1 according to the invention it is possible to ascertain the enthalpy position of the working fluid by precisely controlled—preferably electrical —supply of energy through the sub-stream evaporator 12. In this way, in particular, the steam portion of the working fluid in the wet steam region can be determined, even though the temperature and pressure of the working fluid are constant. This is the foundation for a fast and robust regulating of the waste heat utilization assembly 1. According to the invention, with the present arrangement thermal energy is supplied by the sub-stream evaporator 12 not to the entire mass flow of working fluid, which would entail a very large energy outlay, but rather only to a small sub-stream through the auxiliary line 2b.

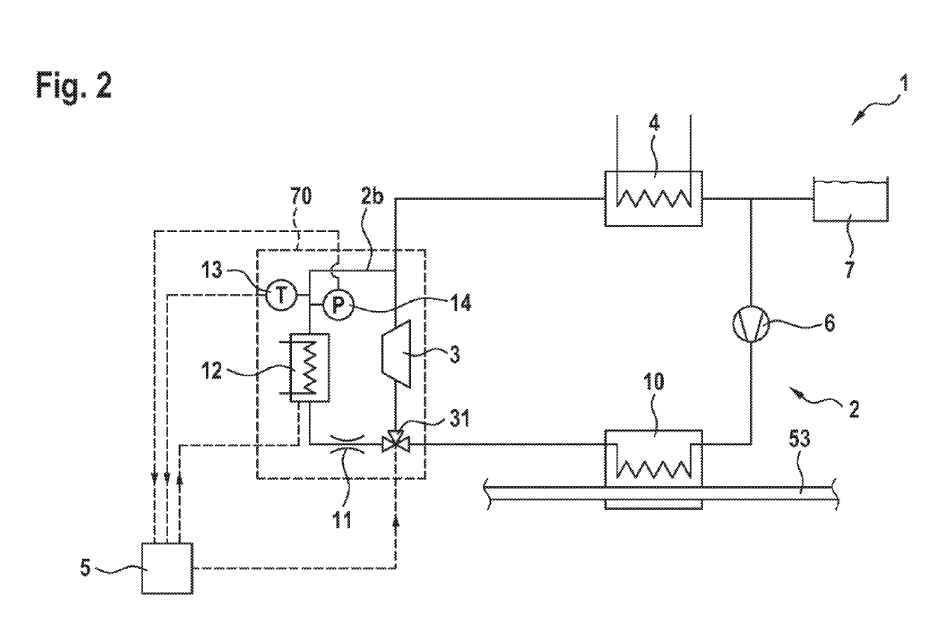

FIG. 2 shows the waste heat utilization assembly 1 according to the invention in another exemplary embodiment. In this embodiment, the auxiliary line 2b is arranged parallel to the expansion machine 3, i.e., as a bypass line to the expansion machine 3. For this, a bypass valve 31 controls the mass flows of the working fluid to the expansion machine 3 and to the auxiliary line 2b or apportions the mass flow of working fluid between the expansion machine 3 and the bypass line. The bypass valve 31 in this case is preferably designed as a proportional valve. Similar to the previous embodiment, the auxiliary line 2b comprises the throttle 11, the sub-stream evaporator 12, the pressure sensor 14 and the temperature sensor 13. However, thanks to the design of the bypass valve 31 as a proportional valve, in alternative embodiments the throttle 11 may even be eliminated from the auxiliary line 2b.

The control unit 5 actuates the bypass valve 31 and thus supplies to the sub-stream evaporator 12 the sub-stream of the working fluid needed to regulate the waste heat utilization assembly 1, which can also take place only at selected moments of time.

Preferably, in this embodiment the expansion machine 3, the bypass valve 31, the throttle 11, the sub-stream evaporator 12, the pressure sensor 14 and the temperature sensor 13 are arranged in a common housing 70.

The embodiment of FIG. 2 is especially advantageous, since the auxiliary line 2b as a bypass line to the expansion machine 3 is necessary anyway, because the working fluid in event of too large a liquid fraction needs to be taken past the expansion machine 3, in order to avoid damage to the expansion machine 3.

In one modification, the auxiliary line 2b can also be arranged inside the bypass line as a parallel circuit.

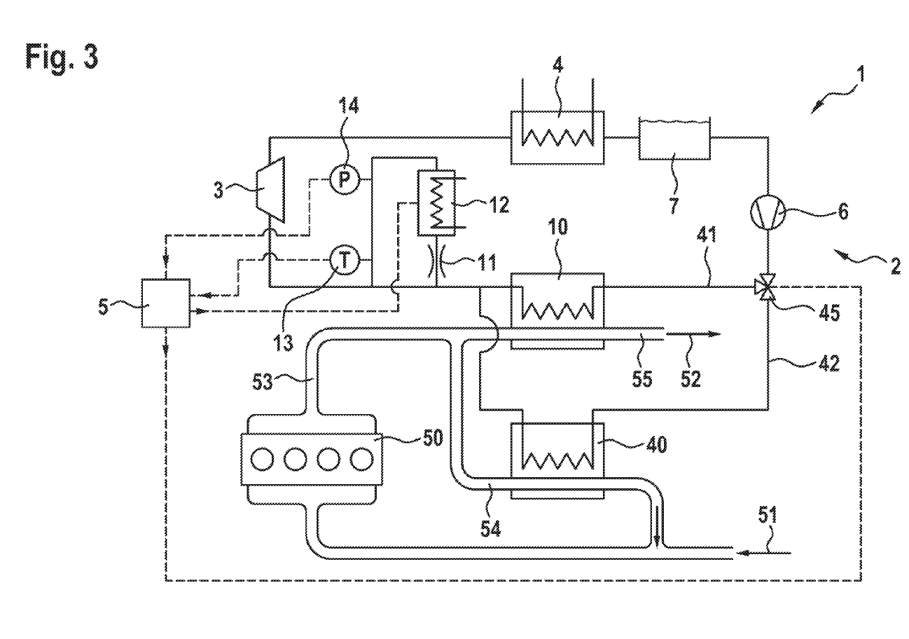

FIG. 3 shows another embodiment of the waste heat utilization assembly 1 according to the invention. In this embodiment, the working circuit 2 comprises a parallel circuit of two evaporators: the evaporator 10 and a further evaporator 40. The evaporator 10 is arranged here in a first parallel line 41 and the further evaporator 40 in a second parallel line 42. A distributor valve 45 apportions the mass flow of working fluid supplied by the feed pump 6 between the two parallel lines 41, 42, the distributor valve 45 being actuated by the control unit 5.

The internal combustion engine 50 of the embodiment of FIG. 3 comprises a recirculation duct 54. The internal combustion engine 50 at the intake side is supplied with fresh air 51 and also optionally recirculated exhaust gas from the recirculation duct 54. At the outlet side, exhaust gas is expelled from the internal combustion engine 50 into the exhaust tract 53.

The exhaust tract 54 branches into the recirculation duct 54 and an end duct 55. Through the end duct 55, the exhaust gas gets to the surroundings, possibly after going through after-treatment systems, not shown.

The evaporator 10 is arranged in the end duct 55, the further evaporator 40 in the recirculation duct 54.

The working circuit 2 thus comprises, in the direction of flow of the working fluid, the collecting tank 7, the feed pump 6, the distributor valve 45, the parallel circuit of the first parallel line 41 and the second parallel line 42, the expansion machine 3 and the condenser 4.

According to the invention, the auxiliary line 2b is arranged between the parallel circuit of the first parallel line 41 and the second parallel line 42 and the expansion machine 3, parallel to the working circuit 2. Similar to the previous embodiments, there are arranged in the auxiliary line 2b, in the direction of flow of the working fluid, the throttle 11 and the sub-stream evaporator 12. Downstream of the sub-stream evaporator 12 are arranged furthermore the temperature sensor 13 and the pressure sensor 14. Preferably, the throttle 11 during operation throttles the mass flow of the working fluid so that only a small fraction flows through the auxiliary line 2b.

The two sensors 13, 14 relay data or signals to the control unit 5, which processes them further. The control unit 5 controls the energy supplied to the auxiliary line 2b by the sub-stream evaporator 12.

In alternative embodiments with two evaporators 10, 40 in the working circuit 2, the auxiliary line 2b can also be arranged parallel to the expansion machine 3, as described in FIG. 2.

Furthermore, the possibility also exists in waste heat utilization assemblies with a parallel circuit of two evaporators 10, 40 to employ two sub-stream evaporators, i.e., one in each parallel line 41, 42. This is described in the following exemplary embodiment.

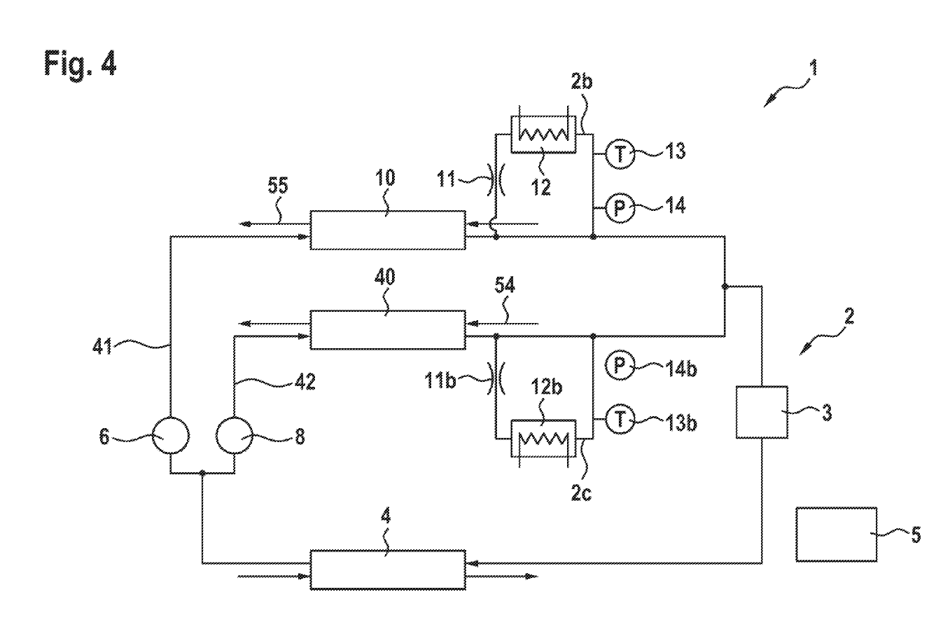

The working circuit 2 of the exemplary embodiment of FIG. 4 comprises, in the direction of flow of the working fluid, a parallel circuit of the first parallel line 41 and the second parallel line 42, the expansion machine 3 and the condenser 4. In the first parallel line 41 are arranged the feed pump 6 and the evaporator 10. In the second parallel line 42 are arranged a further feed pump 8 and the further evaporator 40. Optionally, the collecting tank 7 may be arranged in the working circuit 2 or in a feed line, not shown.

The evaporator 10 is supplied with exhaust gas heat from the end duct 55, the further evaporator 40 with exhaust gas heat from the recirculation duct 54.

The arrangement of two feed pumps 6, 8 in a parallel circuit of two evaporators 10, 40 is generally possible for all embodiments as an alternative to an arrangement of one feed pump 6 and one distributor valve 45. Accordingly, the exemplary embodiment of FIG. 3 can be modified alternatively.

In the first parallel line 41, the auxiliary line 2b is connected in parallel, downstream of the evaporator 10. Similar to the preceding embodiments, the throttle 11 and the sub-stream evaporator 12 are arranged in the direction of flow of the working fluid in the auxiliary line 2b. Furthermore, the temperature sensor 13 and the pressure sensor 14 are arranged downstream of the sub-stream evaporator 12.

In the second parallel line 42, a further auxiliary line 2c is connected in parallel, downstream of the further evaporator 40. The further auxiliary line 2c comprises, in the direction of flow of the working fluid, a further throttle llb and a further sub-stream evaporator 12b. Furthermore, a further temperature sensor 13b and a further pressure sensor 14b are arranged downstream of the further sub-stream evaporator 12b.

In this way, the enthalpy can be ascertained both for the working fluid flowing through the first parallel line 41 and for the working fluid flowing through the second parallel line 42.

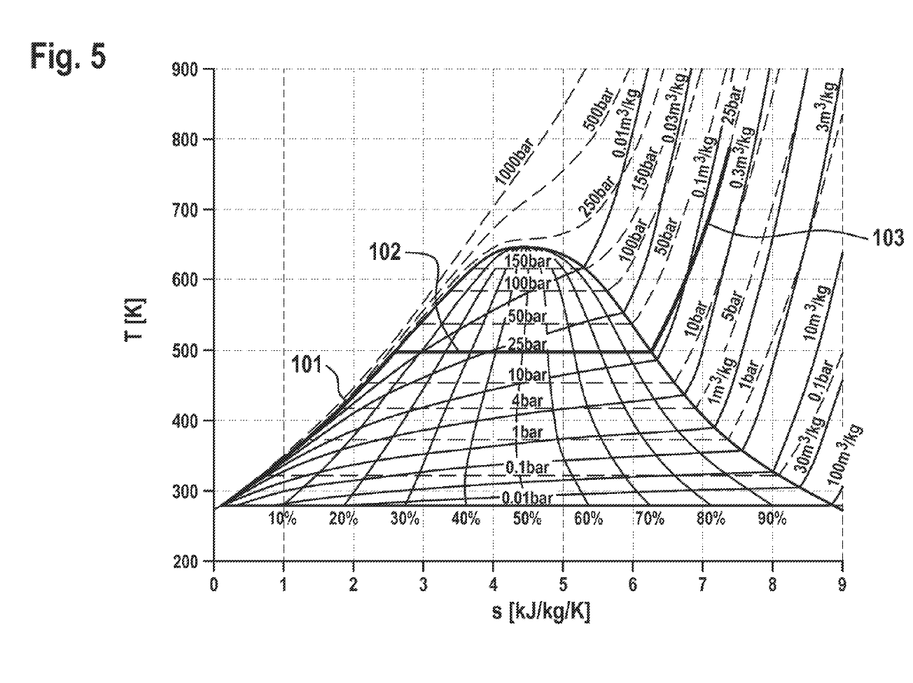

FIG. 5 shows an exemplary entropy/temperature diagram of a waste heat utilization assembly, especially the waste heat utilization assembly 1 according to the invention. The temperature T [K] is plotted in terms of the entropy s [kJ/kg/K]. If thermal energy is supplied to the working fluid by the evaporator 10, three diagram lines 101, 102, 103 describe the variation in the state of the working fluid:

liquid line 101: the temperature of the liquid working fluid rises in almost isobaric manner up to the boiling temperature

wet steam line 102: the working fluid is evaporated at constant temperature and constant pressure

steam line 103: from saturation, the temperature of the evaporated working fluid continues to rise.

The functioning of the waste heat utilization assembly 1 is as follows.

The feed pump 6 delivers liquid working fluid under pressure from the collecting tank 7 to the evaporator 10 and/or optionally to the further evaporator 40. In the evaporators 10, 40, the working fluid is evaporated isobarically and then supplied to the expansion machine 3. In the expansion machine 3, the gaseous working fluid is expanded and thereby performs mechanical work, which can be supplied for example in the form of a torque to an output shaft of the internal combustion engine 50 or to a generator. The working fluid is then liquefied once more in the condenser 4 and taken thereafter to the collecting tank 7.

In order to liquefy the working fluid in the condenser 4, thermal energy is withdrawn from it there. The condenser 4 is therefore advantageously arranged at the same time in the cooling circuit 20 of the internal combustion engine 50, while any other cooling circuit could also be used for this.

According to the invention, sensors are arranged primarily in the working circuit 2 in order to operate the working circuit 2 in a particular temperature range and pressure range and advantageously also to operate the cooling circuit below a particular limit temperature. In the working circuits of the prior art, it is not possible to determine the exact state point of the working fluid in the wet steam region, i.e., on the wet steam line 102, since no temperature or pressure changes occur here. If the working fluid is situated to the right of the wet steam line 102—i.e., almost in the saturated region—and if thermal energy continues to be supplied to the working fluid by the evaporator 10, the danger exists of overheating the working circuit 2 and its components. This is especially critical because in the region of the steam line 103 even a slight energy change already results in a very large temperature change. In these temperature regions, the strengths of the components diminish greatly with rising temperature. On the other hand, no working fluid in the wet steam state should get into the expansion machine 3, since this is inefficient or would result in damage such as cavitation damage in the expansion machine 3. Accordingly, the operating region of the working fluid should preferably be chosen to be very narrow for the expansion machine 3, namely, with the lowest possible temperature T, yet still as saturated steam, i.e., as much as possible beneath the steam line 103.

For this, according to the invention, a sub-stream evaporator 12 is arranged in an auxiliary line 2b to the working circuit 2. The crux of the invention is to carry out a precise, controlled (preferably electrical) energy supply via the sub-stream evaporator 12 and to measure the particular position on the entropy/temperature diagram or the enthalpy of the working fluid. This method is more efficient than the quantities of energy supplied from the exhaust tract 53, which are often inaccurately measured or estimated. Furthermore, this method requires no knowledge of the mass flow of exhaust gas.

The method according to the invention has instead the advantage that it can regulate the waste heat utilization assembly 1 relative to its current state and needs no absolute error-prone quantities for the regulation.

So as not to have to supply thermal energy to the entire mass flow of the working fluid, for example by electrical energy, in the method for enthalpy determination this is done “representatively” for only a sub-stream by the auxiliary line 2b. Preferably, the sub-stream is distinctly less than the total flow in this case. As a result, on the one hand the energy outlay for the enthalpy determination is kept within bounds, and on the other hand the system is hardly affected by the enthalpy determination.

The method according to the invention for determining the enthalpy point of the working fluid, when the state of the working fluid is in the wet steam region—i.e., the wet steam line 102—is as follows:

A sub-stream is withdrawn by the constant throttle 11 from the total flow of working fluid through the working circuit 2. The apportionment of the mass flows is thus known thanks to the constant throttle ratio of the sub-stream to the main flow. If the control unit 5 determines, for example by the temperature sensor 13, a wet steam state of the working fluid upstream from the expansion machine 3, the next method steps can be commenced. A precisely known (electrical) heat quantity is supplied to the sub-stream. Enough energy is supplied in this case so that the sub-stream arrives at the superheating region, i.e., the region of the steam line 103. This is checked or monitored with the temperature sensor 13 and/or the pressure sensor 14.

When the superheating is reached, it is thus also known how much energy was supplied by the sub-stream evaporator 12. In turn, from this one may exactly calculate, through the throttle ratio, how much energy had to be supplied to the main flow or the total flow of the working fluid in the working circuit 2 in order to reach the superheating region. Conversely, it can also be computed how much the total flow of the working fluid needs to be reduced in order to reach a given point of the superheating for the same energy supply by the evaporator 10.

A further benefit of this method is that the mass flow of the working fluid through the working circuit 2 and the energy quantity supplied by the evaporator 10 need not be known with exactitude, since the regulation process is done relative to the precisely known energy in the auxiliary line 2b that is supplied by the sub-stream evaporator 12. Thus, a drift in the mass flow of working fluid or a drift in the heat flow transfer of the evaporator 10 over its service life is irrelevant. As a result, this method is very robust over the service life of the waste heat utilization assembly 1.

If the working fluid is in the superheated steam state, the control or regulation of the system can be done with the methods known from the prior art. Alternatively or additionally, however, the control or regulation can also be done through the temperature sensor 13 and the pressure sensor 14, or also through the further temperature sensor 13b and the further pressure sensor 14b.

1. A waste heat utilization assembly (1) of an internal combustion engine (50), comprising a working circuit (2) that conducts a working fluid, wherein there are arranged in the working circuit (2), in a direction of flow of the working fluid, a feed pump (6), an evaporator (10), an expansion machine (3) and a condenser (4), wherein the evaporator (10) is also arranged in an exhaust tract (53) of the internal combustion engine (50), and between the evaporator (10) and the condenser (4) an auxiliary line (2b) is connected in parallel to the working circuit (2), characterized in that a sub-stream evaporator (12) is arranged in the auxiliary line (2b) and furthermore a pressure sensor (14) and/or a temperature sensor (13) are arranged in the auxiliary line (2b), the pressure sensor (14) and/or the temperature sensor (13) being arranged downstream of the sub-stream evaporator (12).

2. The waste heat utilization assembly (1) according to claim 1, characterized in that the sub-stream evaporator is actuable by a control unit (5).

3. The waste heat utilization assembly (1) according to claim 1, characterized in that the sub-stream evaporator (12) is operable with electric energy.

4. The waste heat utilization assembly (1) according to claim 1, characterized in that a throttle (11) is arranged in the auxiliary line (2b) upstream of the sub-stream evaporator (12).

5. The waste heat utilization assembly (1) according to claim 1, characterized in that the auxiliary line (2b) is arranged between the evaporator (10) and the expansion machine (3).

6. The waste heat utilization assembly (1) according to claim 1, characterized in that the auxiliary line (2b) is designed as a bypass line to the expansion machine (3).

7. The waste heat utilization assembly (1) according to claim 6, characterized in that a bypass valve (31) divides the mass flow of the working fluid between the expansion machine (3) and the auxiliary line (2b).

8. The waste heat utilization assembly (1) according to claim 1, characterized in that the working circuit (2) comprises a parallel circuit with a first parallel line (41) and a second parallel line (42), wherein the evaporator (10) is arranged in the first parallel line (41), and a further evaporator (40) is arranged in the second parallel line (42).

9. The waste heat utilization assembly (1) according to claim 8, characterized in that the auxiliary line (2b) is arranged as a parallel circuit in the first parallel line (41) and another auxiliary line (2c) with another sub-stream evaporator (12b) is arranged as a parallel circuit in the second parallel line (42).

10. A method for operating a waste heat utilization assembly (1) of an internal combustion engine (50), wherein the waste heat utilization assembly (1) comprises a working circuit (2) that conducts a working fluid, wherein there are arranged in the working circuit (2), in a direction of flow of the working fluid, a feed pump (6), an evaporator (10), an expansion machine (3) and a condenser (4), wherein the evaporator (10) is also arranged in an exhaust tract (53) of the internal combustion engine (50), and between the evaporator (10) and the expansion machine (3) an auxiliary line (2b) is connected in parallel to the working circuit (2), wherein a sub-stream evaporator (12) is arranged in the auxiliary line (2b) and furthermore a pressure sensor (14) and/or a temperature sensor (13) are arranged in the auxiliary line (2b), the pressure sensor (14) and/or the temperature sensor (13) being arranged downstream of the sub-stream evaporator (12), wherein the waste heat utilization assembly (1) comprises a control unit (5),
the method comprising the following method steps:
determining a wet steam state of the working fluid by the control unit (5) by means of the temperature and/or pressure of the working fluid;
increasing the heat output of the sub-stream evaporator (12) to the auxiliary line (2b) by the control unit (5), until the working fluid flowing through the auxiliary line (2b) reaches a superheated steam state; and
determining by the control unit (5) the partial heat quantity of the heat input needed to reach the superheated steam state.

11. The method according to claim 10, wherein the working circuit (2) comprises a parallel circuit with a first parallel line (41) and a second parallel line (42), wherein the evaporator (10) is arranged in the first parallel line (41), and a further evaporator (40) is arranged in the second parallel line (42), wherein the auxiliary line (2b) is arranged as a parallel circuit in the first parallel line (41) and wherein another auxiliary line (2c) with another sub-stream evaporator (12b) is arranged as a parallel circuit in the second parallel line (42), characterized in that the control unit (5) increases a heat output of the other sub-stream evaporator (12b) to the other auxiliary line (2c) until the working fluid flowing through the other auxiliary line (2c) reaches a superheated steam state.

12. The method for operating a waste heat utilization assembly (1) of an internal combustion engine (50), wherein the waste heat utilization assembly (1) comprises a working circuit (2) that conducts a working fluid, wherein there are arranged in the working circuit (2), in a direction of flow of the working fluid, a feed pump (6), an evaporator (10), an expansion machine (3) and a condenser (4), wherein the evaporator (10) is also arranged in an exhaust tract (53) of the internal combustion engine (50), and an auxiliary line (2b) is connected as a bypass line in parallel to the expansion machine (3), wherein a sub-stream evaporator (12), a pressure sensor (14) and/or a temperature sensor (13) are arranged in the auxiliary line (2b), the pressure sensor (14) and/or the temperature sensor (13) being arranged downstream of the sub-stream evaporator (12), wherein the waste heat utilization assembly (1) comprises a control unit (5),
the method comprising the following method steps:
determining a wet steam state of the working fluid by the control unit (5) by means of the temperature and/or pressure of the working fluid;
increasing the heat output of the sub-stream evaporator (12) to the auxiliary line (2b) by the control unit (5), until the working fluid flowing through the auxiliary line (2b) reaches a superheated steam state; and
determining by the control unit (5) of the partial heat quantity of the heat input needed to reach the superheated steam state.

13. The method according to claim 12, wherein a bypass valve (31) divides the mass flow of the working fluid between the expansion machine (3) and the auxiliary line (2b), characterized in that the control unit (5) controls the bypass valve (31) so that no working fluid in the wet steam state flows through the expansion machine (3).

14. The method according to claim 10, characterized in that the control unit (5) determines a total heat quantity needed to achieve the superheated steam state of the working fluid in the working circuit (2).

15. The method according to claim 14, characterized in that the control unit (5) actuates the feed pump (6) so that the mass flow of working fluid through the working circuit (2) is decreased in accordance with the required total heat quantity.
